(19) United States
(12) Patent Application Publication
(10) Pub. No.: US 2007/0188313 A1
(43) Pub. Date: Aug. 16, 2007

(54) Multi-purposed in-vehicle information display module

(75) Inventor: Tony Huang, Taipei (TW)

Correspondence Address: TROXELL LAW OFFICE PLLC, 5205 LEESBURG PIKE, SUITE 1404, FALLS CHURCH, VA, 22041, US

(73) Assignee: Promate Electronic Co., Ltd.

(21) Appl. No.: 11/352,355

(22) Filed: Feb. 13, 2006

(51) Int. Cl. B60Q 1/00

(52) U.S. Cl. 340/438

(57) ABSTRACT

The present invention relates to a type of multi-purposed in-vehicle information display module. The invention comprises: a SoC (System-on-Chip), a memory device, and a TFT-LCD display panel. The SoC communicates with the vehicle's host processor to retrieve in-vehicle information. The flash ROM is utilized for the storage of the main SoC program and for the storage of the to-be-displayed icons and character fonts. Lastly, the TFT-LCD display panel is connected with the SoC to display all intended in-vehicle information retrieved from the vehicle's host processor.

### FIELD OF THE INVENTION

The present invention relates to a multi-functional in-vehicle active matrix liquid crystal display module. More particularly, the invention is intended to cluster in-vehicle data/information and displays them on a single in-vehicle TFT LCD display panel thus to provide greater information display flexibility. This invention is applied to use in various types of transportation vehicles.

### DESCRIPTION OF THE PRIOR ART

The dashboard on an automobile is an important instrument panel interfacing vehicle information in sight and keeping driver(s) in touch with details/conditions that affect the course of the travel such as traveling speed, distance traveled, fuel consumption, and battery status.

As illustrated in FIG. 1, it shows a design of conventional automobile dashboard A. The dashboard A enables the display of various control dials such as tachometer, speedometer, engine temperature, and battery status. It incorporates a light bulb in its rear or underneath (not shown in the Figure) to provide the dashboard sufficient lighting so that the driver could be properly indicated even under poor external lighting conditions.

However, the conventional dashboard design as A needs the collocation of a light bulb underneath to actualize its intended effect and thus making the dashboard, as a whole, space consuming. Furthermore, the replacement need of the light bulb at decent intervals adds to the inconvenience; while the arrangements of the indicators and meters on the dashboard accentuate the inflexibility of this design.

### SUMMARY OF THE INVENTION

The primary objective of the present invention is to provide a flexible display solution by combining the indicator and meter functions into a single TFT LCD display module.

The secondary objective of the present invention is to provide a flexible and low-cost multi-functional active matrix liquid crystal display module for automobile.

To achieve the above objectives, the present invention comprises of a SoC (System-on-Chip), a memory device, and a TFT-LCD display panel. The SoC communicates with the automobile's host processor to fetch in-vehicle information. The memory device stores the main program of the SoC and the to be displayed information. The TFT-LCD panel is connected with the SoC. In whole, this allows the SoC to retrieve in-vehicle data from the automobile's host processor and subsequently display them via the TFT-LCD display panel.

The description of the disclosure will be more apparent with the accompanying drawings which show, for purposes of illustration only, a preferred embodiment in accordance with the present invention.

### BRIEF DESCRIPTION OF THE DRAWINGS

FIG. 1 is a perspective view of a conventional automobile dashboard.

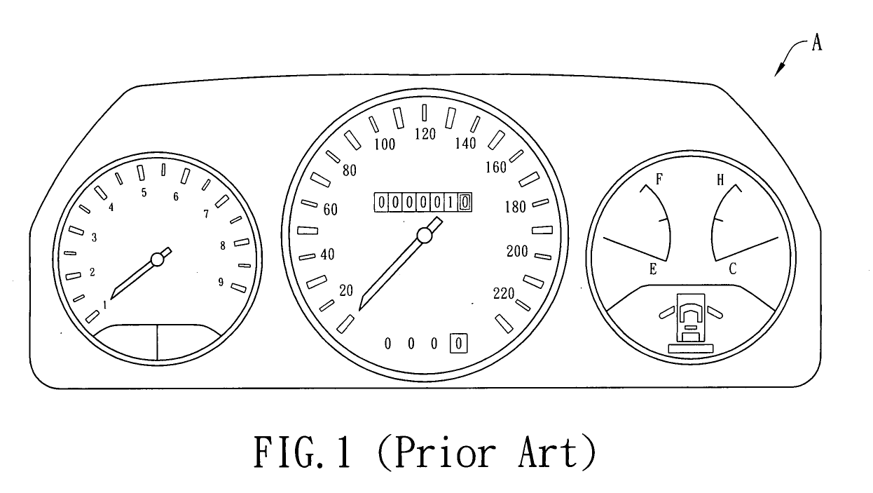

FIG. 2 is a module block diagram of the embodiment of the present invention.

FIG. 3 is an internal structure diagram of a SoC pertaining to the embodiment of the present invention.

FIG. 4 is a schematic view of the icons displayed on the TFT-LCD displayed of the present invention.

FIG. 5 is a module block diagram including the DC/DC module of the embodiment of the present invention.

### DETAILED DESCRIPTION OF THE REFERRED EMBODIMENT

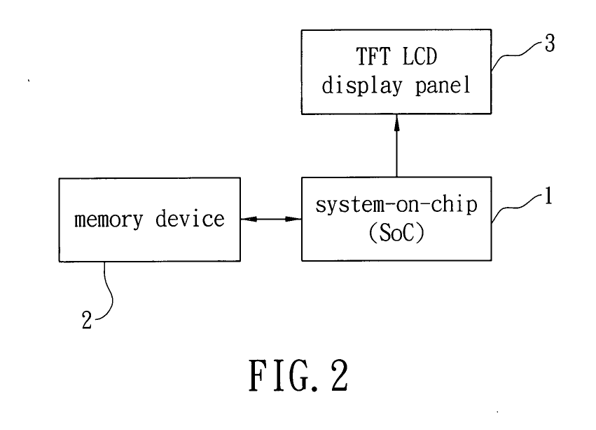

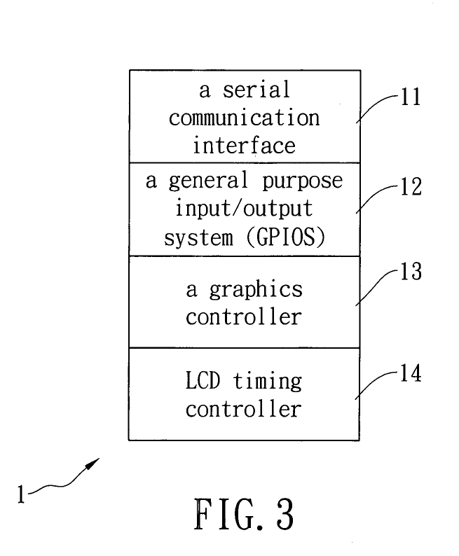

As illustrated in FIGS. 2 and 3, the embodiment of the present invention of a multi-purposed in-vehicle information display module comprises a SoC 1, a memory device 2, and a TFT LCD display panel 3.

The SoC 1 communicates with the automobile's host processor to retrieve in-vehicle information including but not limited to traveling speed, distance traveled, temperature of the engine, fuel consumption, battery status, and seat belt status. The SoC 1 includes a serial communication interface 11, a general purpose input/output module 12 (GPIOS) for input and output usage, a graphics controller 13, and LCD timing controller 14 to control the display of static icons and messages on the LCD panel 3; whereas the dynamic text messages such as the speed of the vehicle, temperature of the engine, and schedule of travel could also be displayed on the LCD 3 via the serial communication interface 11. The GPIOS 12 could emulate the current indicators without intervention from the host CPU.

Flash ROM 2 is the present invention's preferred memory device. The flash memory is connected with the SoC 1 to store the program and data of the SoC 1. These data include but are not limited to the colored and non-colored icons and character fonts.

The SoC 1, with the aid of the serial communication interface 11, could be used to re-program the flash memory 2 and this provides great flexibility to design change and last minute design overrun.

The liquid crystal display panel 3 (TFT-LCD) is connected with the SoC 1 to display in-vehicle information.

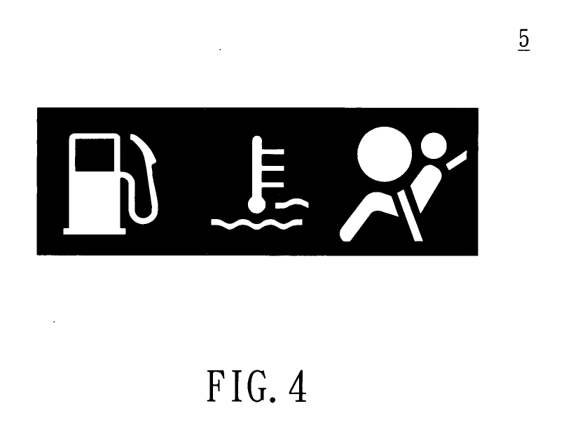

Referring to FIGS. 2-5 to show an embodiment of the invention. Prior to delivering the automobile to the intended buyer, the car manufacturer's engineer could configure the memory device 2 with the SoC 1 via the serial communication interface 11 to ensure that the icons and text messages are to the customer's tastes. Upon initiating the automobile, the SoC 1 will communicate with the vehicle's host processor to retrieve in-vehicle information and channel the information from the SoC 1 via the serial communication interface 11 so that traveling speed, distance traveled, temperature of the engine, fuel consumption, battery status, seat belt status could be clearly displayed on the liquid crystal display panel 3 and indicate in-vehicle information 5 such as overheating of the engine, insufficient fuel, or unfastened seat belt(s) (as illustrated in FIG. 4) to the driver to make necessary precautions.

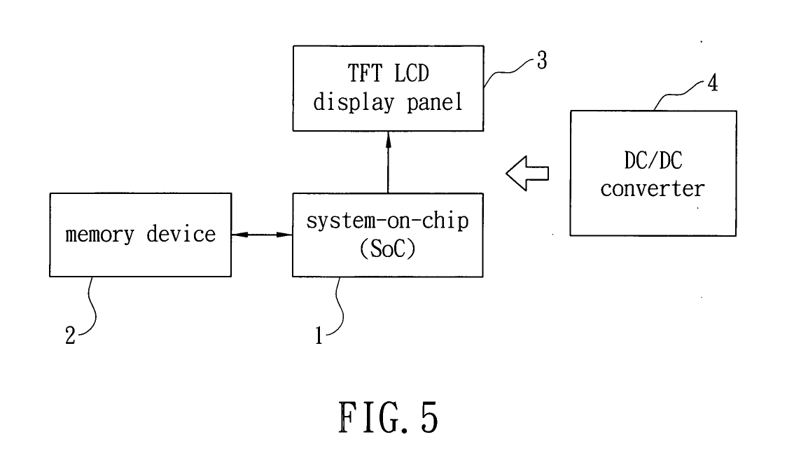

Furthermore, as illustrated in FIG. 5, the present invention further consists of a DC/DC converter 4 to provide the necessary voltage inputs to suit various in-vehicle applications to further reduce overall cost.

The present invention of a multi-purposed in-vehicle information display module thereby has the following practical advantages:
1. The present invention of a multi-purposed in-vehicle information display module uses a SoC to communicate with the automobile's host processor to retrieve various vehicle information and display them as icons or text messages on a TFT-LCD display panel to keep driver(s) in touch with details/conditions that affect the course of the travel so that he/her could take necessary precautions. The display module could be a practical substitute to the conventional dashboard's display module providing longer product life span, higher display resolution and higher added value.
2. The present invention of a multi-purposed in-vehicle information display module offers great flexibility enabling it to adapt to last minute design changes. For instance, it allows design engineers to upload the most recent icons and text messages to the buyers prior to handling the automobile. Furthermore, dissimilar module groups could employ the same display module with the only difference being their display characteristics. Hence, the development cost could still be reduced under diverse design circumstances.

While the embodiment has been shown and described in accordance with the present invention, it should be clear to those skilled in the art that further embodiments may be made without departing from the scope of the present invention.

In sum, the present invention can achieve its anticipated objectives and provide a valuable embodiment of a type of multi-purposed in-vehicle information display module.

What is claimed is:

1. A type of multi-purposed in-vehicle information display module for automobile comprising:
a SoC (System-on-Chip) that communicates with the automobile's host processor to retrieve in-vehicle information;
a memory device that communicates with the SoC and uses to store the main SoC program and information; and
a liquid crystal display panel (TFT-LCD) that is connected with the SoC and used to display intended in-vehicle information.

2. The multi-purposed in-vehicle information display module for automobile as claimed in claim 1, wherein: said serial communication interface is integrated within the said SoC and used to provide in-vehicle information via the serial communication interface to be shown on the display panel, and with the use of the said serial communication interface enable configurations of the memory device at the manufacturer' workstation.

3. The multi-purposed in-vehicle information display module for automobile as claimed in claim 1, wherein: said SoC includes a graphics controller and timing controller to control the display of the in-vehicle information on the display panel.

4. The multi-purposed in-vehicle information display module for automobile as claimed in claim 2, wherein: said SoC includes a graphics controller and timing controller to control the display of the in-vehicle information on the display panel.

5. The multi-purposed in-vehicle information display module for automobile as claimed in claim 1, wherein: said SoC includes a general purpose input/output module for the input and output of designated information and control signals.

6. The multi-purposed in-vehicle information display modules for automobile as claimed in claim 1, wherein: said in-vehicle information includes by not limited to car speed, distance traveled, engine temperature, fuel consumption, battery and seat belt status.

7. The multi-purposed in-vehicle information display module for automobile as claimed in claim 1, wherein: said memory device storage information includes icons figures or character fonts.

8. The multi-purposed in-vehicle information display module for automobile as claimed in claim 7, wherein: said icons figures or character fonts are colored.

9. The multi-purposed in-vehicle information display module for automobile as claimed in claim 1, wherein: said DC/DC converter is further included to provide the voltage for the above mentioned modules.

10. The multi-purposed in-vehicle information display module for automobile as claimed in claim 1, wherein: said memory device is flash memory.
